(19) United States
(12) Patent Application Publication
(10) Pub. No.: US 2016/0298835 A1
(43) Pub. Date: Oct. 13, 2016

(54) LED Lighting Fixture

(71) Applicant: Brightline, Inc., Bridgeville, PA (US)

(72) Inventor: Samuel P. Cercone, Aliquippa, PA (US)

(21) Appl. No.: 15/095,389

(22) Filed: Apr. 11, 2016

Related U.S. Application Data
(60) Provisional application No. 62/145,259, filed on Apr. 9, 2015.

(51) Int. Cl. F21V 29/74; F21S 8/04; F21V 7/05

(52) U.S. Cl. CPC F21V 29/74; F21V 7/05; F21S 8/04; F21Y 2101/02; F21Y 2103/003

(57) ABSTRACT

A lighting fixture which includes at least one lamp assembly coupled between two spaced end plates and supported by a frame coupled, along with a back side of the lamp assembly, to a heat sink. At least one elongated support member is provided that includes a pair of oppositely facing U-channels adapted to receive opposing ends of the heat sink. At least one reflector assembly is provided through which light output by the lamp assembly propagates.

### CROSS REFERENCE TO RELATED APPLICATIONS

The present application claims priority to U.S. Provisional Patent Application Ser. No. 62/145,259 entitled “LED Lighting Fixture” filed Apr. 9, 2015, the entire disclosure of which is hereby incorporated by reference in its entirety.

### BACKGROUND OF THE INVENTION

1. Field of the Invention

The present application relates to LED lighting fixtures for plaster/drywall ceilings and dropped ceilings and, more particularly, to LED lighting fixtures that include heat sinks attached to a frame with U-shaped channel support members and directional reflecting elements.

2. Description of Related Art

Dropped ceilings are well known in the art as secondary ceilings that are hung below a main (structural) ceiling. Dropped ceilings are also referred to as a drop ceiling, false ceiling, or suspended ceiling, and are utilized widely in modern construction and architecture.

It is well known in the art for dropped ceilings to include one or more lighting fixtures that are supported by the grid-work of the dropped ceiling in a plenum space defined in the area above the dropped ceiling.

Plaster or drywall ceilings are also known in the art to include one or more lighting fixtures supported in one or more spaces above the ceilings, typically between joists that define the support structure of the plaster or drywall ceiling.

Heretofore, such lighting fixtures were configured without heat sinks or directional reflecting elements or with heat sinks and directional reflecting elements that were difficult to attach or inadequately constructed. There is, however, a need in certain applications, such as, without limitation, video conferencing, distance learning, telemedicine, internet video streaming, and non-traditional studio environments, where LED lighting fixtures with heat sinks attached to a frame with U-shaped channel support members and directional reflecting elements would be desirable.

### SUMMARY OF THE INVENTION

Various preferred and non-limiting examples will now be described as set forth in the following numbered clauses:

Clause 1: In an example, a lighting fixture is disclosed comprising at least one lamp assembly coupled between two spaced end plates and supported by a frame coupled, along with a back side of the lamp assembly, to a heat sink; at least one elongated support member that includes a pair of oppositely facing U-channels adapted to receive opposing ends of the heat sink; and at least one reflector assembly through which light output by the lamp assembly propagates.

Clause 2: The lighting fixture of clause 1, wherein at least one L-shaped reflector can be disposed between the two spaced end plates.

Clause 3: The lighting fixture of clause 1 or 2, wherein at least one planar reflector can be disposed between the two spaced end plates.

Clause 4: The lighting fixture of any of clauses 1-3, wherein at least one arcuate reflector can be disposed between the two spaced end plates.

Clause 5: The lighting fixture of any of clauses 1-4, wherein the reflector assembly can be comprised of separate sides.

Clause 6: The lighting fixture of any of clauses 1-5, wherein the reflector assembly can be an integral unit.

Clause 7: The lighting fixture of any of clauses 1-6, wherein the heat sink can comprise fins disposed in a direction opposite to an opening where light output by the lamp assembly propagates.

Clause 8: The lighting fixture of any of clauses 1-7, wherein a base of the heat sink can be planar.

Clause 9: The lighting fixture of any of clauses 1-8, wherein a base of the heat sink can be curved.

Clause 10: The lighting fixture of any of clauses 1-9, wherein the at least one lamp assembly can comprise three lamp assemblies, each supported by a distinct frame coupled to a distinct heat sink, wherein the three lamp assemblies can be disposed in an angular manner relative to each other.

Clause 11: The lighting fixture of any of clauses 1-10, wherein a base of the distinct heat sink of at least one of the three lamp assemblies can be curved.

Clause 12: The lighting fixture of any of clauses 1-11, wherein spaced frame members on opposite sides of the lighting fixture can define an opening where light output by the lamp assembly propagates.

Clause 13: The lighting fixture of any of clauses 1-12, wherein at least one of the spaced frame members can be L-shaped.

### BRIEF DESCRIPTION OF THE DRAWING(S)

FIG. 1A is an exploded perspective view of a first example LED light fixture with three lamp assemblies.

FIG. 1B is an assembled cross-section of the LED light fixture shown in FIG. 1A.

FIG. 2A is an exploded perspective view of another example LED light fixture with two lamp assemblies.

FIG. 2B is an assembled cross-section of the LED light fixture shown in FIG. 2A.

FIG. 3A is an exploded perspective view of another example LED light fixture with two lamp assemblies and reflecting elements different than those in FIG. 2A.

FIG. 3B is an assembled cross-section of the LED light fixture shown in FIG. 3A.

FIG. 4A is an exploded perspective view of another example LED light fixture with one lamp assembly.

FIG. 4B is an assembled cross-section of the LED light fixture shown in FIG. 4A.

### DESCRIPTION OF THE INVENTION

The following examples will be described with reference to the accompanying figures where like reference numbers correspond to like or functionally equivalent elements.

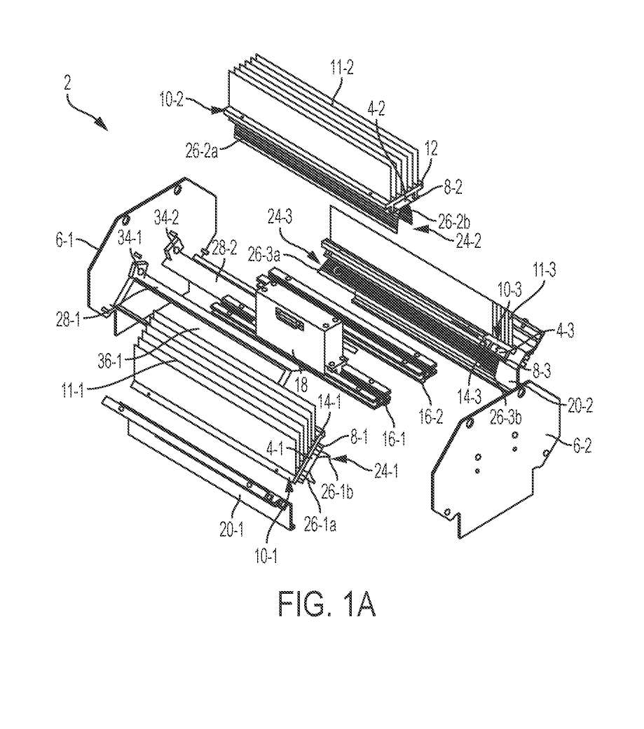

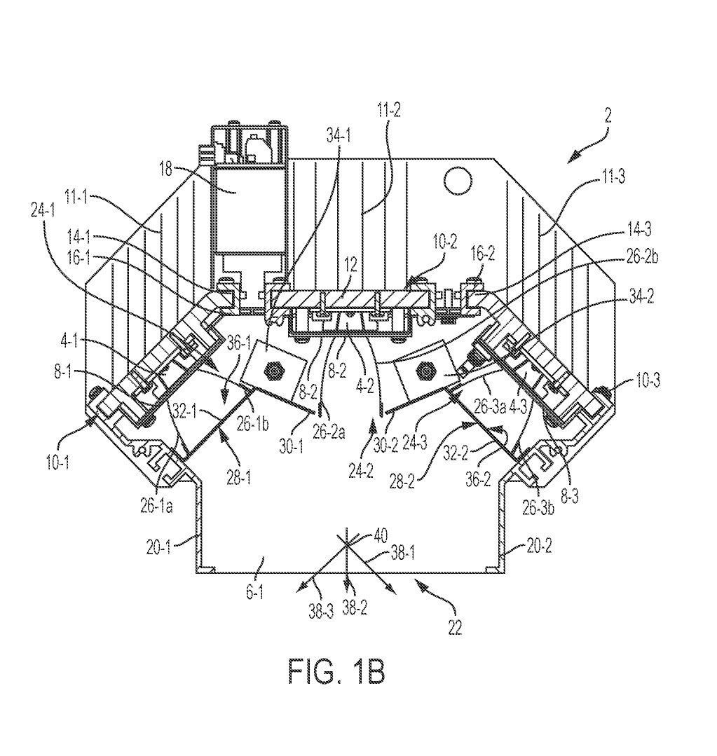

FIGS. 1A and 1B show exploded perspective and cross-sectional assembled views of a first example LED light fixture 2. LED light fixture 2 includes elongated LED lamp assemblies 4-1, 4-2, and 4-3 coupled between a pair of spaced end plates 6-1 and 6-2. LED lamp assemblies 4-1, 4-2, and 4-3 are supported by frames 8-1, 8-2, and 8-3, which are coupled along with a back side of each LED lamp assembly 4, to a corresponding heat sink 10-1, 10-2, and 10-3 via suitable fasteners (not numbered).

As shown in the cross section of FIG. 1B, a top 12 of heat sink 10-2 is substantially planar from side to side. In contrast, heat sinks 10-1 and 10-3 are substantially planar except for upper sides 14-1 and 14-3 which are curved in a manner to substantially align with the left and right side of heat sink 10-2 in the view shown in FIG. 1B.

The opposing sides of heat sinks 10-1 and 10-2 are held in spaced relation by an elongated support 16-1 that includes a pair of oppositely facing U-channels adapted to receive the opposing sides of heat sinks 10-1 and 10-2. Similarly, an elongated support 16-2 includes a pair of oppositely facing U-channels that are adapted to receive the opposing sides of heat sinks 10-2 and 10-3.

LED light fixture 2 includes a power supply 18 that is configured to convert incoming AC power into DC power that is distributed via suitable wiring (not shown) to the individual LEDs (not shown) of each LED lamp assembly 4-1, 4-2, and 4-3. Power supply 18 can be coupled to either support 16-1 or 16-2. In the illustrated example, power supply 18 is coupled to the top of support 16-1.

The lower part of LED light fixture 2 includes a pair of spaced frames 20-1 and 20-2 on opposite sides of LED light fixture 2 which define an opening 22 where light output by LED lamp assemblies 4-1, 4-2, and 4-3 exit LED light fixture 2. LED light assemblies 4-1, 4-2, and 4-3 include reflector assemblies 24-1, 24-2, and 24-3, respectively. Each reflector assembly 24 can be an integral unit or can be comprised of separate sides, namely, sides 26-1a and 26-1b for reflector assembly 24-1; sides 26-2a and 26-2b for reflector assembly 24-2; and sides 26-3a and 26-3b for reflector assembly 24-3.

In an example, each heat sink 10 includes fins 11 that can extend in the same direction, namely, opposite/away from opening 22.

A pair of generally L-shaped reflectors 28-1 and 28-2 are disposed between end plates 6-1 and 6-2. L-shaped reflector 28-1 includes a base 30-1 and a leg 32-1. L-shaped reflector 28-2 includes a base 30-2 and a leg 32-2. The opposites ends of each L-shaped reflector 28-1 and 28-2 are coupled to and/or supported by end plates 6-1 and 6-2, e.g., via tabs 34-1 and 34-2 of L-shaped reflectors 28-1 and 28-2. However, the manner by which L-shaped reflectors 28-1 and 28-2 are supported between end plates 6-1 and 6-2 is not to be construed in a limiting sense.

L-shaped reflectors 28-1 and 28-2 include openings 36-1 and 36-2 through which light output by LED lamp assemblies 4-1 and 4-3 propagate. The opening 36-1 in L-shaped reflector 28-1 is shown best in FIG. 1A.

As can be seen in FIG. 1B, the longitudinal axes of LED lamp assemblies 4-1 and 4-3 are at the same vertical distance from opening 22 and the horizontal axis of LED lamp assembly 4-2 is at a different, greater vertical distance from opening 22.

Rays of light output by LED lamp assemblies 4-1, 4-2, and 4-3 (shown by arrows 38-1, 38-2, and 38-3, respectively) cross at a point 40 between frames 20-1 and 20-2. However, this is not to be construed in a limiting sense.

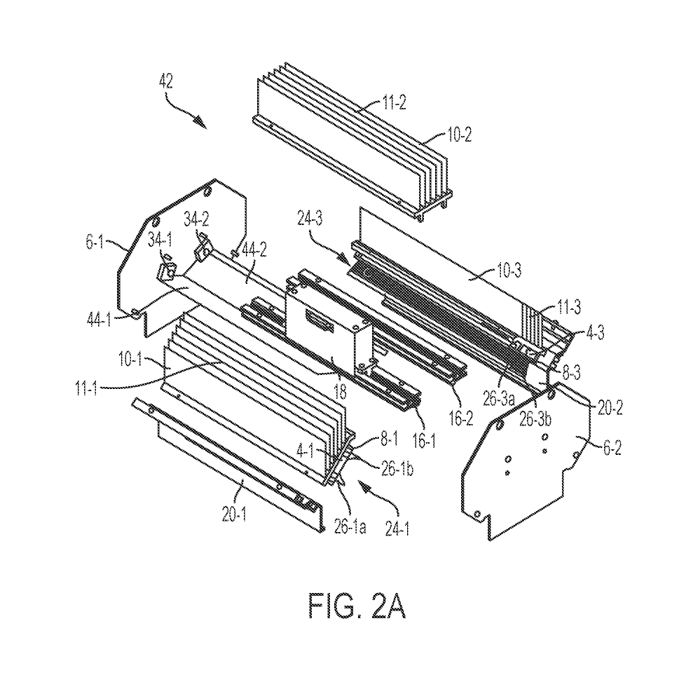

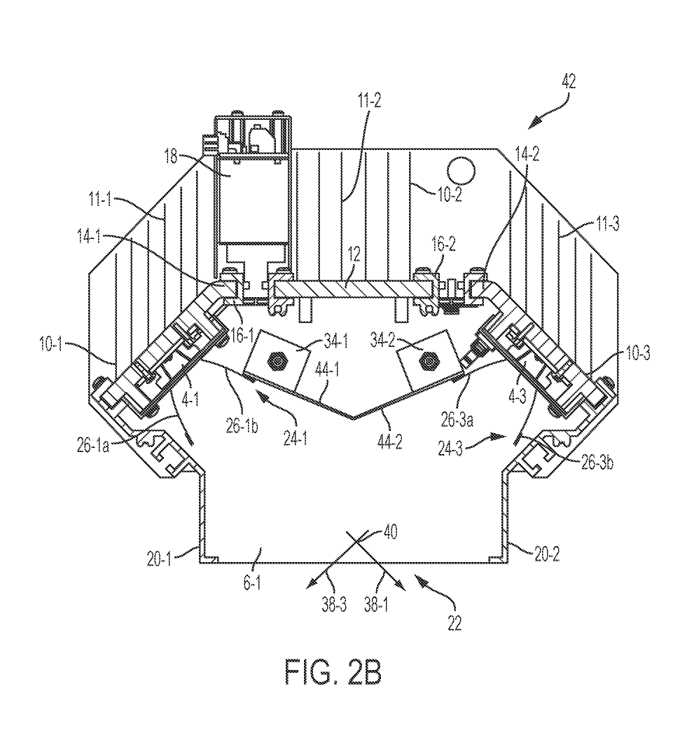

With reference to FIGS. 2A and 2B and with continuing reference to FIGS. 1A and 1B, a second example LED light fixture 42 is similar in many respects to the first example LED light fixture 2 shown in FIGS. 1A and 1B, with at least the following exceptions. In second example LED light fixture 42, lamp assembly 4-2, frame 8-2, reflector assembly 24-2, and the related fasteners are omitted over the first example LED light fixture 2. Also, L-shaped reflectors 28-1 and 28-2 have been omitted and are replaced with planar reflectors 44-1 and 44-2.

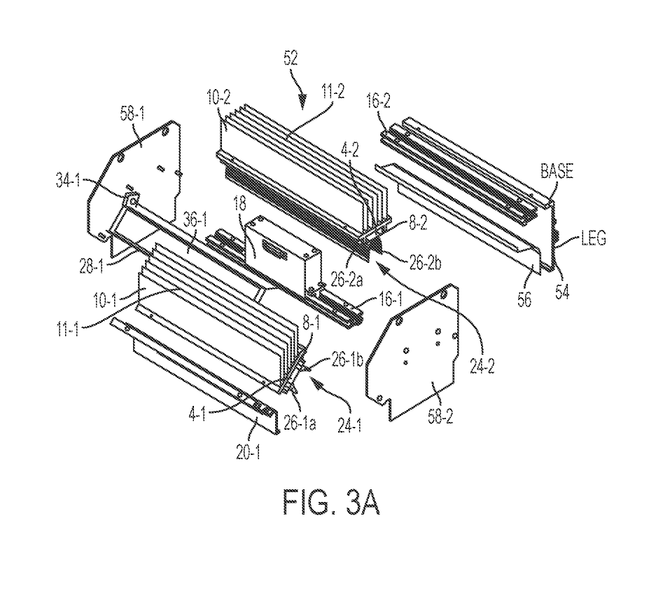

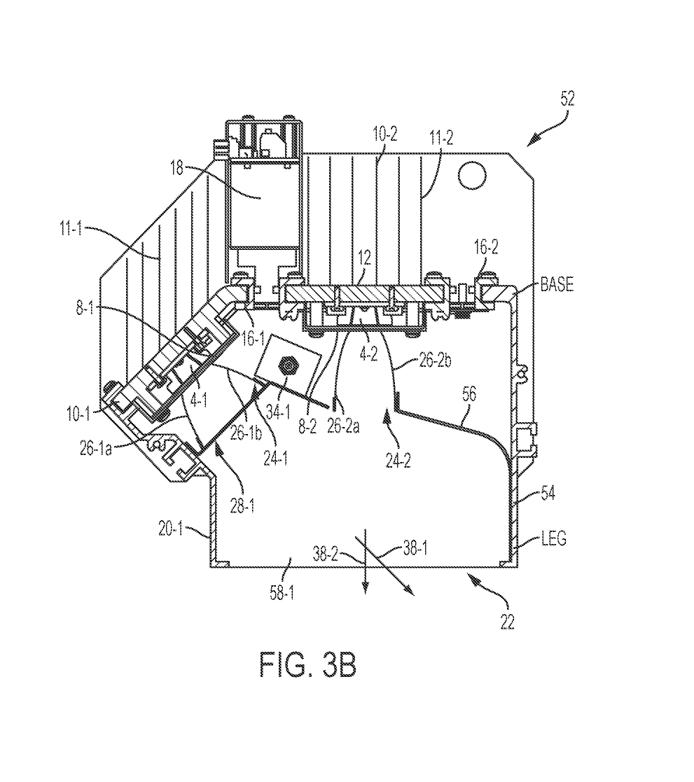

A third example LED light fixture 52 shown in FIGS. 3A and 3B is similar in many respects to the first example LED light fixture 2, with at least the following exceptions. Third example LED light fixture 52 does not include LED lamp assembly 4-3, heat sink 10-3, L-shaped reflector 28-2, frame 20-2, reflector assembly 24-3, frame 8-3, and tab 34-2 found in the first example LED light fixture 2. In replacement of some or all these components, third example LED light fixture 52 includes an L-shaped frame 54 having its base connected to support 16-2 and having its leg extending downward and forming with the lower part of frame 20-1 opening 22. An arcuate reflector 56 extends between the lower end of the leg of L-shaped frame 54 and side 26-2b of reflector assembly 24-2. Finally, third example LED light fixture 52 includes end plates 58-1 and 58-2 at opposite ends thereof in place of end plates 6-1 and 6-2 in first example LED light fixture 2. As can be seen, end plates 58-1 and 58-2 have a different shape than plates 6-1 and 6-2 to account for the omission of LED lamp assembly 4-3, heat sink 10-3, and related hardware from the first example LED light fixture 2 shown in FIGS. 1A and 1B.

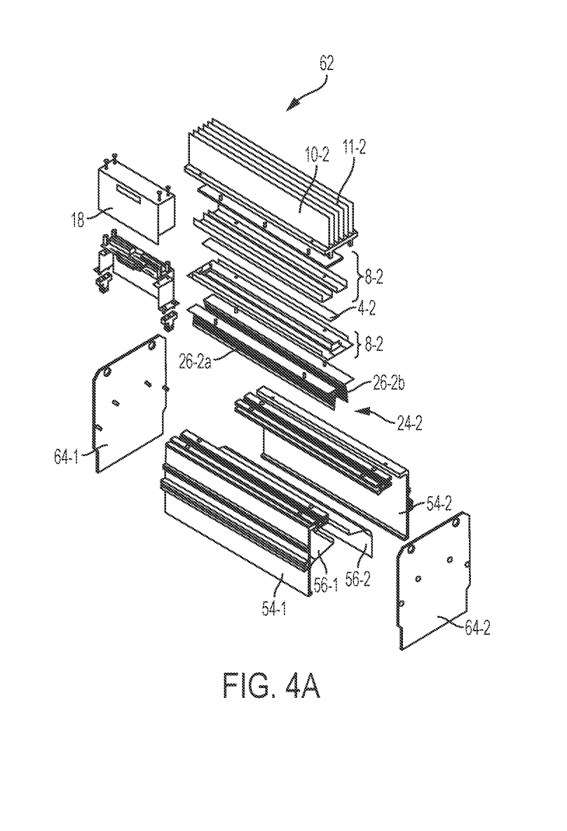

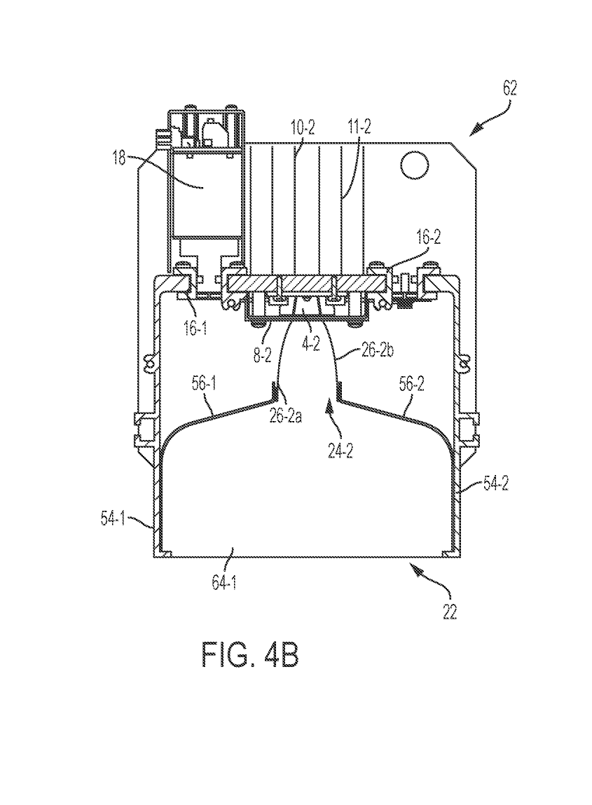

Finally, a fourth example LED light fixture 62 shown in FIGS. 4A and 4B is similar in many respects to the third example light fixture 52 shown in FIGS. 3A and 3B, with at least with the following exceptions. Comparing FIGS. 3B and 4B, it can be seen that the fourth example LED light fixture shown in FIG. 4B does not include LED lamp assembly 4-1, reflector assembly 24-1, L-shaped reflector 28-1, frame 20-1, heat sink 10-1, and tab 34-1 shown in the third example LED light fixture 52 of FIG. 3B. Rather, in full or partial replacement of these elements, fourth example light fixture 62 includes L-shaped frames 54-1 and 54-2 on opposite sides thereof that define opening 22. Arcuate reflectors 56-1 and 56-2 extend from sides 26-2a and 26-2b, respectively, of reflector assembly 24-2 to the bottom of L-shaped frames 54-1 and 54-2. Finally, fourth example LED light fixture 62 includes end plates 64-1 and 64-2 which are shaped differently than end plates 58-1 and 58-2 of the third example LED light fixture 42 to account for the omission of LED lamp assembly 4-1, heat sink 10-1, and related hardware and the substitution of L-shaped frame 54-1 for frame 20-1.

The examples have been described with reference to the accompanying figures.

Modifications and alterations will occur to others upon reading and understanding the foregoing examples. Accordingly, the foregoing examples are not to be construed as limiting the disclosure

The invention claimed is:

1. A lighting fixture comprising:
at least one lamp assembly coupled between two spaced end plates and supported by a frame coupled, along with a back side of the lamp assembly, to a heat sink;
at least one elongated support member that includes a pair of oppositely facing U-channels adapted to receive opposing ends of the heat sink; and
at least one reflector assembly through which light output by the lamp assembly propagates.

2. The lighting fixture of claim 1, further comprising at least one L-shaped reflector disposed between the two spaced end plates.

3. The lighting fixture of claim 1, further comprising at least one planar reflector disposed between the two spaced end plates.

4. The lighting fixture of claim 1, further comprising at least one arcuate reflector disposed between the two spaced end plates.

5. The lighting fixture of claim 1, wherein the reflector assembly is comprised of separate sides.

6. The lighting fixture of claim 1, wherein the reflector assembly is an integral unit.

7. The lighting fixture of claim 1, wherein the heat sink comprises fins disposed in a direction opposite to an opening where light output by the lamp assembly propagates.

8. The lighting fixture of claim 1 wherein a base of the heat sink is planar.

9. The lighting fixture of claim 1 wherein a base of the heat sink is curved.

10. The lighting fixture of claim 1, wherein the at least one lamp assembly comprises three lamp assemblies, each supported by a distinct frame coupled to a distinct heat sink, wherein the three lamp assemblies are disposed in an angular manner relative to each other.

11. The lighting fixture of claim 10, wherein a base of the distinct heat sink of at least one of the three lamp assemblies is curved.

12. The lighting fixture of claim 1, wherein spaced frame members on opposite sides of the lighting fixture define an opening where light output by the lamp assembly propagates.

13. The lighting fixture of claim 12, wherein at least one of the spaced frame members is L-shaped.
